(19) United States
(12) Patent Application Publication
(10) Pub. No.: US 2003/0231921 A1
(43) Pub. Date: Dec. 18, 2003

(54) Writing implement

(75) Inventor: Man-Hwa Baik, Seoul (KR)

Correspondence Address: Plumsea Law Group, LLC, Suite 320, 10411 Motor City Drive, Bethesda, MD, 20817, US

(73) Assignee: Morris Pen Corporation, Incheon (KR)

(21) Appl. No.: 10/371,158

(22) Filed: Feb. 24, 2003

(30) Foreign Application Priority Data
Feb. 22, 2002 (KR) 2002-5307

(51) Int. Cl. B43K 5/00

(52) U.S. Cl. 401/199; 401/198

(57) ABSTRACT

Disclosed is a writing implement capable of preventing ink from being excessively dispensed in response to change of temperature or pressure in a reservoir, or an outer impact. The writing implement according to the one embodiment of the present invention includes a housing, a reservoir for storing ink within the housing, an ink supplying pipe for guiding flow of the ink, an ink feeder for absorbing and storing the ink moving through the ink supplying pipe from the reservoir to control a current rate of the ink, a buffer for temporally storing the ink during reducing pressure differential between the reservoir and atmosphere, and a tip for conveying the ink from the ink feeder to a substrate. In the writing implement as constructed above, even though the ink excessively moves to the tip with expansion in response to change of temperature or pressure in the reservoir, the ink feeder and buffer temporarily stores a part of the ink, resulting in regularly supplying the ink to the tip.

### BACKGROUND OF THE INVENTION

1. Field of the Invention

The present invention relates to a writing implement, and more particularly to a writing implement capable of preventing discharge of excessive ink which is caused by an increase of pressure in the writing implement or an outer impact.

2. Description of the Related Art

It is well known to provide a pen having free ink that a user can selectively apply to a substrate such as paper, metal, or plastic. Such known pens typically include a reservoir for storing the ink and a channel for directing the ink from the reservoir to a marking tip. The ink of such known pens typically has a vapor pressure such that the ink, and any air in the reservoir, expands and contracts in response to changes in ambient temperature and pressure. Such expansion and contraction can cause the ink to leak from the writing tip of the pen, under certain conditions.

Other such known pens include a buffer for storing ink that would otherwise leak through the tip in response to changes in ambient temperature and pressure. The excess ink is typically stored in the front of the buffer, near the tip of the pen, due to gravity, when the pen is in the tip-down position. However, such known pens have several disadvantages: the ink capacity of the buffer is limited such that when the buffer is full the excess ink leaks from the pen, and the ink is often permanently stored in the buffer resulting in decreased buffer capacity and wasted ink. Another of such known pens provides for the clearing of ink from the buffer when the pressure inside the pen increases by venting air into the pen through an external vent. Such known pens, however, clear only a small portion of the buffer. Still other pens have achieved hydrostatic stability, but only with design restrictions that require stringent manufacturing tolerances and result in reduced ink flow rates.

U.S. patent application Ser. No. 10/106,552 (filed by Witz et al. on Mar. 26, 2002, and already published on Nov. 14, 2002) discloses a hydrostatically stable writing implement in which ink is hardly leaked in response to changes in temperature and pressure and which has a design freedom and improved current rate of the ink.

FIG. 1 is a longitudinally sectional view of the writing implement 10 according to the above-mentioned Witz's patent application. As shown in FIG. 1, the writing implement 10 according to the above-mentioned patent application includes a housing 12, a reservoir 14 for storing ink within the housing 12, a feed tube 16 which is communicated with the reservoir 14, for supplying the ink, a tip 18 which is disposed in the feed tube 16, for conveying the ink to a substrate at an end thereof, a porous buffer 20 which is disposed to be adjacent to the feed tube 16 in the housing 12, for storing the ink during a period of decreasing pressure differential between the reservoir 14 and atmosphere, and bubble separation area 22 in the form of a hole or passage in the feed tube 16 or between the feed tube 16 and the tip 18.

The ink stored in the reservoir 14 of the housing 12 moves through the feed tube 16 to the tip 18. When the excessive ink moves to the tip 18, the porous buffer 20 absorbs and stores a part of the ink by capillarity thereof.

When the changes in temperature and pressure of atmosphere cause the air and the ink in the reservoir 14 to expand and move through the feed tube 16 to the tip 18, meanwhile, the buffer 20 absorbs and stores the part of the ink.

In the writing implement 10 according to the Witz's patent application, however, since the tip 18 has the capillarity different from that of the buffer 20, the ink stored in the buffer 20 moves to the tip 18 by the capillarity thereof when the buffer 20 stores a large quantity of the ink. Thereby, a great amount of the ink which is more than a necessary quantity, leaks from the tip 18.

### SUMMARY OF THE INVENTION

The present invention has been developed to solve the above-mentioned problem. It is an object of the present invention to provide a writing implement capable of preventing the ink from being excessively dispensed in response to changes in temperature and pressure in a reservoir, or an outer impact.

In order to achieve the object of the present invention, according to an embodiment of the present invention, there is provided a writing implement which comprises: a housing; a reservoir for storing ink within the housing; an ink supplying pipe which is communicated with the reservoir, for guiding flow of the ink; an ink feeder which is disposed in the ink supplying pipe, for absorbing and storing the ink which flows through the ink supplying pipe from the reservoir so as to control a current rate of the ink; a buffer which is disposed in the housing with enclosing an outer peripheral surface of the ink supplying pipe, for temporally storing the ink during reducing pressure differential between the reservoir and atmosphere; and a tip which is disposed in the housing, for conveying the ink from the ink feeder to a substrate, the tip having one end which comes in contact with one ends pf the ink supplying pipe and the ink feeder and the other end which extends out of the housing.

According to the embodiment of the present invention, a plurality of ribs are formed at a distance from one another on an inner peripheral surface of the housing to extend at a predetermined length from an end of the housing, along which air moves into the housing when the ink is conveyed from the tip to the substrate.

The ink supplying pipe includes a circular head portion which has a diameter corresponding to an inner diameter of the housing and in which a slit is radially formed at an area spaced at a predetermined distance apart from a center thereof.

A plurality of slots are formed at a predetermined distance from one another along the outer peripheral surface of the ink supplying pipe, through which excessive ink supplied to the ink feeder moves to the buffer.

The buffer has one end which comes in contact with the head portion of the ink supplying pipe and the other end which encloses one end of the tip, of which the outer peripheral surface comes in contact with the inner peripheral surface of the housing.

In the writing implement according to the embodiment of the present invention which is constructed as described above, even though the ink excessively expanses and moves to the tip in response to change in temperature or pressure in the reservoir, the ink feeder and buffer temporarily stores a part of the ink, resulting in regularly supplying the ink to the tip.

### BRIEF DESCRIPTION OF THE DRAWINGS

The above objects and advantages of the present invention will become more apparent by describing in detail the preferred embodiments thereof with reference to the attached drawings, in which:

FIG. 1 is a longitudinally sectional view of a writing implement according to the conventional art;

FIG. 2 is a longitudinally sectional view of a writing implement according to a first embodiment of the present invention;

FIG. 3 is a longitudinally sectional view of a writing implement according to a second embodiment of the present invention;

FIG. 4 is a longitudinally sectional view of a writing implement according to a third embodiment of the present invention;

FIG. 5 is a longitudinally sectional view of a writing implement according to a fourth embodiment of the present invention;

FIG. 6 is a longitudinally sectional view of a writing implement according to a fifth embodiment of the present invention;

FIG. 7 is a partially enlarged sectional view of the writing implement according to the fifth embodiment of the present invention;

FIG. 8 is a cross-sectional view of the writing implement according to the fifth embodiment of the present invention, taken along a line D-D′;

FIG. 9 is a cross-sectional view of the writing implement according to the first embodiment of the present invention, taken along a line A-A′ in FIG. 2;

FIG. 10 is a cross-sectional view of the writing implement according to the first embodiment of the present invention, taken along a line A-A′ in FIG. 2, in which the other ink supplying pipe is applied to the writing implement;

FIG. 11 is a cross-sectional view of the writing implement according to the first embodiment of the present invention, taken along a line B-B′ in FIG. 2;

FIG. 12 is a cross-sectional view of the writing implement according to the first embodiment of the present invention, taken along a line C-C′ in FIG. 2;

FIG. 13 is an exploded view of an ink supplying pipe applicable to the writing implements according to the first, second, third, fourth and fifth embodiments of the present invention, in which a plurality of slots are formed along an outer peripheral surface of the ink supplying pipe at a predetermined portion of the ink supplying pipe;

FIG. 14 is an exploded view of another ink supplying pipe applicable to the writing implements according to the first, second, third, fourth and fifth embodiments of the present invention, in which a plurality of thru-holes are formed along an outer peripheral surface of the ink supplying pipe at a predetermined portion of the ink supplying pipe;

FIG. 15 is an exploded view of still another ink supplying pipe applicable to the writing implements according to the first, second, third, fourth and fifth embodiments of the present invention, in which a mesh member is mounted in the ink supplying pipe;

FIG. 16 is a sectional view of a first modification of an ink supplying pipe applicable to the writing implements according to the first, second, third, fourth and fifth embodiments of the present invention;

FIG. 17 is a sectional view of a second modification of the other ink supplying pipe applicable to the writing implements according to the first, second, third, fourth and fifth embodiments of the present invention;

FIG. 18 is a sectional view of an intercepting member applicable to the writing implements according to the first, second, third and fourth embodiments of the present invention;

FIG. 19 is a sectional view of a first modification of a tip applicable to the writing implements according to the first, second, third, fourth and fifth embodiments of the present invention; and

FIG. 20 is a sectional view of a second modification of a tip applicable to the writing implements according to the first, second, third, fourth and fifth embodiments of the present invention.

### DETAILED DESCRIPTION OF THE INVENTION

Hereinafter, a writing implement according to the embodiments of the present invention will be described in more detail with reference to the accompanying drawings. The like reference numeral indicates the like element.

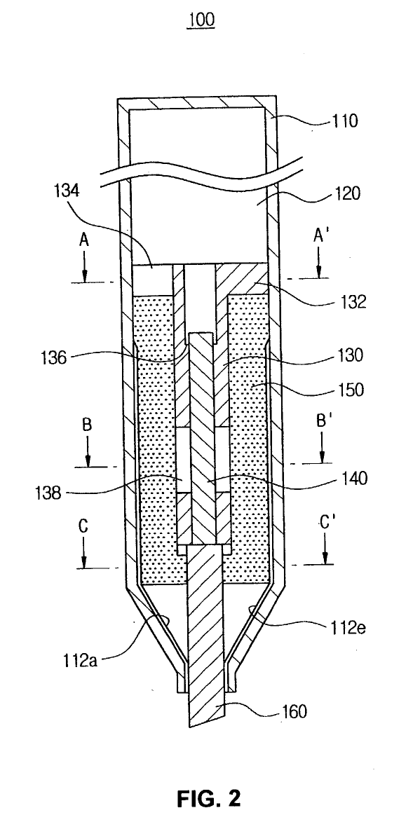

FIG. 2 is a longitudinally sectional view of a writing implement 100 according to the first embodiment of the present invention. As shown in FIG. 2, the writing implement 100 according to the first embodiment of the present invention comprises a housing 110, a reservoir 120 for storing ink within the housing 110, an ink supplying pipe 130 which is communicated with the reservoir 120, for guiding flow of the ink, an ink feeder 140 which is disposed in the ink supplying pipe 130, for absorbing and storing the ink which flows through the ink supplying pipe 130 from the reservoir 120 so as to control a current rate of the ink, a buffer 150 which is disposed in the housing 110 with enclosing an outer peripheral surface of the ink supplying pipe 130, for temporally storing the ink during decreasing pressure differential between the reservoir 120 and atmosphere, and a tip 160 which is disposed in the housing 110, for conveying the ink from the ink feeder 140 to a substrate (not shown), the tip 160 having one end which comes in contact with one ends pf the ink supplying pipe 130 and the ink feeder 140 and the other end which extends out of the housing 110.

The housing 110 has one end air-tightly enclosed and the other end having a truncated conical shape. The tip 160 is inserted at the one end into the housing 110. A plurality of ribs 112a, 112b, 112c, 112d, 112e, 112f, 112g and 112h are formed at a predetermined distance from one another on an inner peripheral surface of the housing 110 to extend at a predetermined length from the other end of the housing 110, along which air moves into the housing 110 when the ink is conveyed from the tip 160 to the substrate (not shown).

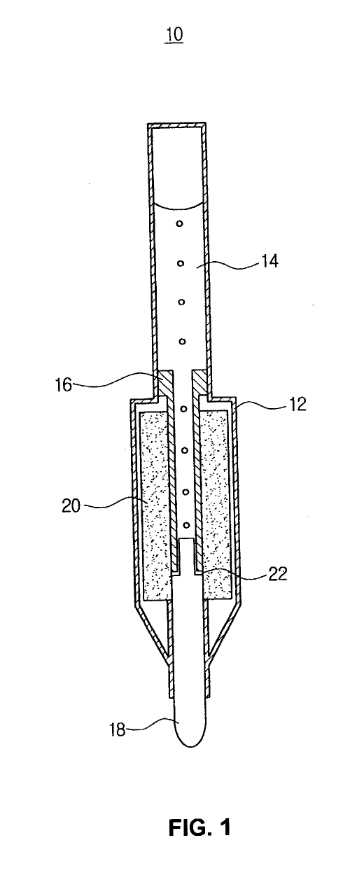

As shown in FIGS. 1 and 9, the ink supplying pipe 130 has a circular head portion 132 of which a diameter is in correspondence to an inner diameter of the housing 110 and in which a slot 134 is radially formed from a position spaced at a predetermined distance from a center portion thereof. The head portion 132 has an outer peripheral surface to be in close contact with the inner peripheral surface of the housing 110.

A step portion 136 is formed in an inner peripheral surface of the ink supplying pipe 130. A thru-hole extending from the step portion 136 to one end of the ink supplying pipe 130 has a smaller diameter than that of a thru-hole extending from the head portion 132 to the step portion 136.

At an area adjacent to the end of the ink supplying pipe 130, furthermore, a plurality of slots 138 are formed at a predetermined distance from one another along a peripheral surface of the ink supplying pipe 130, through which the excessive ink supplied to the ink feeder 140 moves to the buffer 150.

The area of the ink supplying pipe 130 in which the slots 138 are formed has a thickness of about 0.1 mm to 0.5 mm according to properties of the ink, for examples surface tension, viscosity, specific gravity, and the like. When the ink supplying pipe 130 has the thickness less than 0.1 mm, the ink feeder 140 is placed adjacent to the buffer 150 in the presence of the slots 138 between the ink feeder 140 and the buffer 150, so that the ink excessively moves by the capillarity of the buffer 150 from the ink feeder 140 to the buffer 150. When the ink supplying pipe 130 has the thickness more than 0.5 mm, on the other hand, the ink feeder 140 is spaced apart from the buffer 150 in the presence of the slots 138 between the ink feeder 140 and the buffer 150, so that the capillarity of the buffer 150 cannot make an effect on the ink feeder 140 even if the excessive ink is supplied to the ink feeder 140. Thus, the excessive ink supplied to the ink feeder 140 does move not to the buffer 150 but to the tip 160.

The ink feeder 140 is inserted in the ink supplying pipe 130 in which one end of the ink feeder 140 extends through the step portion 136 of the ink supplying pipe 130 while the other end of the ink feeder 140 is placed in the same plane along with the one end of the ink supplying pipe 130. Accordingly, the one end of the ink feeder 140 comes in contact with the tip 160 along with the one end of the ink supplying pipe 130. The ink feeder 140 temporarily stores the ink introduced from the reservoir 120 into the ink supplying pipe 130, which regularly supplies the stored ink to the tip 160.

When the increase of the temperature and the pressure in the reservoir causes the excessive ink to move to the ink feeder 140, the ink leaks and moves through the slots 138 formed in the ink supplying pipe 130 from the ink feeder 140 to the buffer 150. The ink moving to the buffer 150 is absorbed by the capillarity of the buffer 150 to be temporarily stored in the buffer 150.

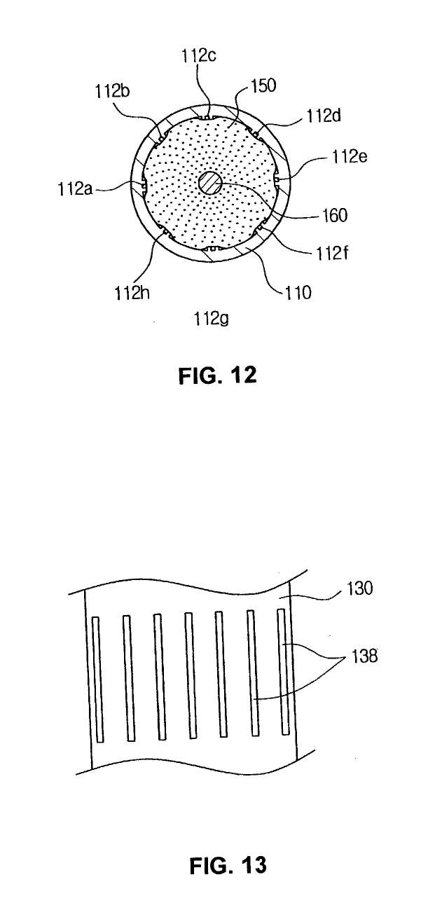

The buffer 150 is made of synthetic material, which is a porous and cylindrical tube. The buffer 150 has one end coming in contact with the head portion 132 of the ink supplying pipe 130, and the other end enclosing the one end of the tip 160. The outer peripheral surface of the buffer 150 comes in close contact with the inner peripheral surface of the housing 110. Meanwhile, the certain portions of the outer peripheral surface of the buffer 150 contacting with the ribs 112a, 112b, 112c, 112d, 112e, 112f, 112g and 112h are inwardly pushed by means of the ribs 112a, 112b, 112c, 112d, 112e, 112f, 112g and 112h, as shown in FIGS. 11 and 12. Furthermore, the inner peripheral surface of the buffer 150 comes in tight contact with the outer peripheral surface of the ink supplying pipe 130.

The buffer 150 contains the air which is introduced into the housing 110 along the ribs 112a, 112b, 112c, 112d, 112e, 112f, 112g and 112h while the ink moves through the tip 160 to the substrate. In addition, the buffer 150 stores the ink which is introduced through the slit 134, which is formed in the head portion 132 of the ink supplying pipe 130, from the reservoir 120 into the buffer 150. The air stored in the buffer 150 moves to the reservoir 120 through the head portion 132 of the ink supplying pipe 130 until the pressure in the housing 110 makes in a state of equilibrium to the atmosphere pressure.

Further, the buffer 150 absorbs and temporarily stores the ink stored in the ink feeder 140 and the tip 160 by the capillarity thereof when the excessive ink is supplied to the ink feeder 140 and the tip 160.

Hereinafter, an operation of the writing implement 100 according to the first embodiment of the present invention will be described in detail.

In the writing implement 100 according to the first embodiment of the present invention which is constructed as described above, the ink is stored in the reservoir 120 of the housing 110. When a user uses the writing implement 100, or when the ink expands in response to the changes in the temperature and the pressure, the ink moves to the ink feeder 140 and the buffer 150 through the ink supplying pipe 130 and the slit 134 formed in the head portion 132 of the ink supplying pipe 130.

Most of the ink flows into the ink supplying pipe 130, which is stored in the ink feeder 140. A part of the ink is introduced through the slit 134 into the buffer 150. The ink stored in the ink feeder 140 moves to the tip 160 by gravity and the capillarity of the ink feeder 140. The ink moving to the tip 160 in the ink feeder 140 is introduced into the buffer 150 through the slit 134 of the ink supplying pipe 130 until the pressure in the housing 110 equilibriums the atmosphere pressure.

The ink introduced into the buffer 150 is temporarily stored in the buffer 150. The ink moves to the ink feeder 140 or the tip 160 as the ink in the tip 160 is spent.

On the other hand, while the ink moves from the reservoir 120 to the ink feeder 140 and the buffer 150, the air flows from the other end of the housing 110 into the housing 110 along the surfaces of the ribs 112a, 112b, 112c, 112d, 112e, 112f, 112g and 112h formed on the inner peripheral surface of the housing 110. Thus, the pressure in a space between the buffer 150 and the other end of the housing 110 is equal to the atmosphere pressure.

The air introduced into the housing 110 is partially absorbed by the buffer 150 as moving to the reservoir 120 along the surfaces of the ribs 112a, 112b, 112c, 112d, 112e, 112f, 112g and 112h which come in contact with the outer peripheral surface of the buffer 150.

The air absorbed in the ink feeder stays in a form of bubble, which moves to the reservoir 120 through the slit 134 formed in the head portion 132 of the ink supplying pipe 130 when the ink is introduced from the reservoir 120 and the ink feeder 140. When the ink moves from the reservoir 120 to the buffer 150 and the ink feeder 140, accordingly, a drop of the pressure in the reservoir 120 can be compensated.

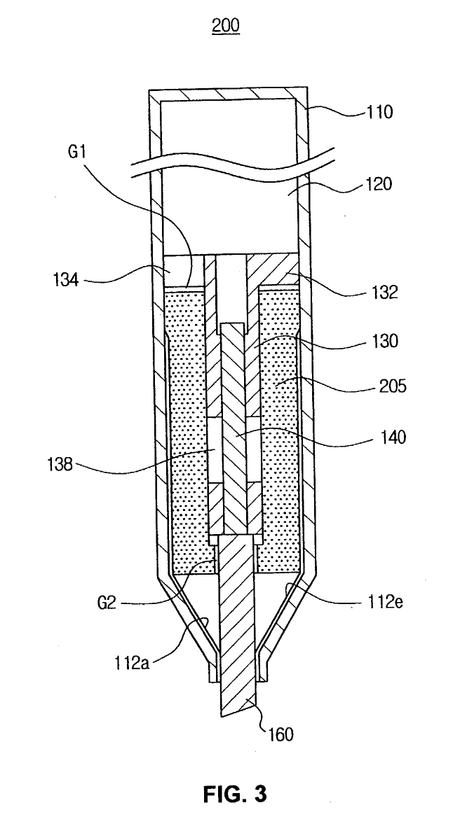

FIG. 3 is a longitudinally sectional view of the writing implement 200 according to the second embodiment of the present invention. As shown in FIG. 3, the writing implement 200 according to the second embodiment of the present invention has the same structure as that of the writing implement 100 according to the first embodiment of the present invention, except for a buffer 250. Therefore, the description relating to the same elements will be omitted.

The buffer 250 applied to the writing implement 200 according to the second embodiment of the present invention has a shorter length that the buffer 150 applied to the writing implement 100 according to the first embodiment of the present invention, of which an inner diameter at one end is larger than that at one end of the buffer 150.

The buffer 250 has one end which is spaced at a predetermined distance G1 from the head portion 132 of the ink supplying pipe 130, and the other end which is spaced at a predetermined distance G2 from the outer peripheral surface of the tip 160 with enclosing the one end of the tip 160. Also, the buffer 250 has an outer peripheral surface coming in contact with the housing 110. Thus, a gap G2 is defined between the inner peripheral surface of the other end of the buffer 250 and the outer peripheral surface of the one end of the tip 160.

In the writing implement 200 according to the second embodiment of the present invention which is constructed as described above, the ink is stored in the reservoir 120 of the housing 110. When a user uses the writing implement 200, or when the ink expands in response to the changes in the temperature and the pressure, the ink moves to the ink feeder 140 and the buffer 250 through the ink supplying pipe 130, the slit 134 formed in the head portion 132 of the ink supplying pipe 130, and the gap G1.

Most of the ink flows into the ink supplying pipe 130, which is stored in the ink feeder 140. A part of the ink is introduced through the slit 134 and the gap G1 into the buffer 150. The ink stored in the ink feeder 140 moves to the tip 160 by gravity and the capillarity of the ink feeder 140. The ink moving to the tip 160 in the ink feeder 140 is introduced into the buffer 250 through the slit 134 of the ink supplying pipe 130 until the pressure in the housing 110 equilibriums the atmosphere pressure.

The ink introduced into the buffer 250 is temporarily stored in the buffer 250. The ink moves to the ink feeder 140 or the tip 160 as the ink in the tip 160 is spent.

On the other hand, while the ink moves from the reservoir 120 to the ink feeder 140 and the buffer 250, the air flows from the other end of the housing 110 into the housing 110 along the surfaces of the ribs 112a, 112b, 112c, 112d, 112e, 112f, 112g and 112h formed on the inner peripheral surface of the housing 110. Thus, the pressure in a space between the buffer 250 and the other end of the housing 110 is equal to the atmosphere pressure.

The air introduced into the housing 110 is partially absorbed by the buffer 250 as moving to the reservoir 120 along the surfaces of the ribs 112a, 112b, 112c, 112d, 112e, 112f, 112g and 112h which come in contact with the outer peripheral surface of the buffer 250.

The air absorbed in the ink feeder stays in a form of bubble, which moves to the reservoir 120 through the slit 134 formed in the head portion 132 of the ink supplying pipe 130 when the ink is introduced from the reservoir 120 and the ink feeder 140. When the ink moves from the reservoir 120 to the buffer 250 and the ink feeder 140, accordingly, a drop of the pressure in the reservoir 120 can be compensated.

Furthermore, the gap G1 defined between the one end of the tip 160 and the buffer 250 functions to prevent the ink which moves the ink feeder 140 to the tip 160, from flowing back.

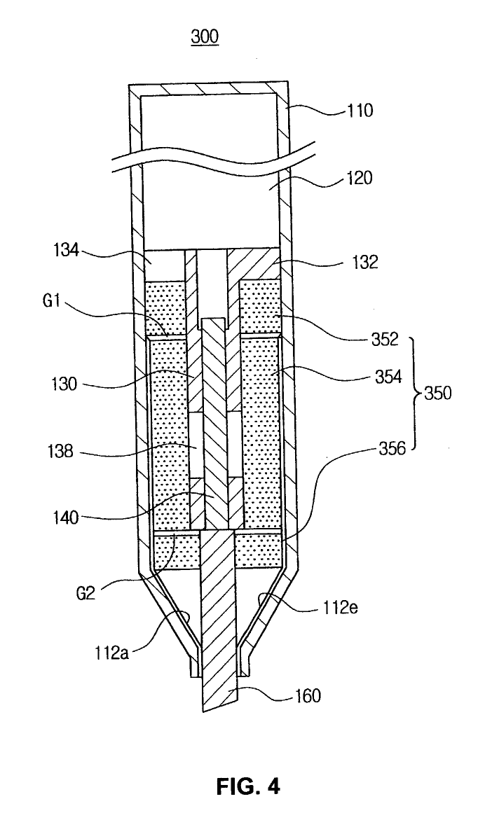

FIG. 4 is a longitudinally sectional view of a writing implement 300 according to the third embodiment of the present invention. As shown in FIG. 4, the writing implement 300 according to the third embodiment of the present invention has the same structure as that of the writing implement 100 according to the first embodiment of the present invention, except for a buffer 350. Thus, the description relating to the same elements will be omitted.

The buffer 350 applied to the writing implement 300 according to the third embodiment of the present invention includes a first buffer 352, a second buffer 354 and a third buffer 356. The first and second buffers 352 and 354 are disposed in the housing 110 to enclose the ink supplying pipe 130 while the third buffer 356 is placed in the housing 110 to enclose the one end of the tip 160.

The first buffer 352 has a surface which comes in contact with the head portion 132 of the ink supplying pipe 130, and the other surface which is opposite at a desired distance G1 to a surface of the second buffer 354.

The second buffer 354 of which the surface faces to the other surface of the first buffer 352 has the other surface opposite to one surface of the third buffer 356 at a desired distance G2. Furthermore, the other surface of the second buffer 354 faces to a part of the one end of the ink supplying pipe 130.

Meanwhile, one ends of the ribs 112a, 112b, 112c, 112d, 112e, 112f, 112g and 112h which are formed on the inner peripheral surface of the housing 110, are positioned in the gap G1 defined between the first buffer 352 and the second buffer 354. The air moves along the ribs 112a, 112b, 112c, 112d, 112e, 112f, 112g and 112h from atmosphere into the housing 110, which is received in the gap G1 between the first buffer 352 and the second buffer 354. A part of the air in the gap G1 is introduced and stored in the first buffer 352 and the remainder of the air stay in the gap G1. The air introduced in the first buffer 352 moves to the reservoir 120 through the slit 134 formed in the head portion 132 of the ink supplying pipe 130 so as to compensate a drop of the pressure in the reservoir 120 which is caused as the ink moves from the reservoir 120 to the ink supplying pipe 130 and the first buffer 352.

In the writing implement 300 according to the third embodiment of the present invention which is constructed as described above, the ink is stored in the reservoir 120 of the housing 110. When a user uses the writing implement 300 or when the ink expands in response to the changes in temperature and pressure in the reservoir 120, the ink moves to the ink feeder 140 and the first buffer 352 through the ink supplying pipe 130 and the slit 134 formed in the head portion 132 of the ink supplying pipe 130.

Most of the ink is introduced into the ink supplying pipe 130, which is stored in the ink feeder 140. The remainder of the ink is introduced through the slit 134 into the first buffer 352. The gap G1 defined between the first buffer 352 and the second buffer 354 restrains the ink introduced into the first buffer 352 from moving to the second buffer 354. The ink stored in the ink feeder 140 moves to the tip 160 by means of gravity and the capillarity of the ink feeder 140. The ink moving to the tip 160 in the ink feeder 140 is introduced into the second buffer 354 through the slot 138 of the ink supplying pipe until the pressure in the housing 110 makes a state of equilibrium to the atmosphere.

The ink introduced into the second buffer 354 is temporarily stored in the second buffer 354. The ink in second buffer 354 moves to the ink feeder 140 as the ink in the tip 160 is spent.

When the excessive ink is introduced from the ink feeder 140 into the tip 160, a part of the ink in the tip 160 moves to the third buffer 356 by the capillarity of the third buffer 356 to be stored in the third buffer 356. When the ink in the tip 160 is spent, then, the ink is introduced from the third buffer 356 and the ink feeder 140 to the tip 160.

While the ink moves from the reservoir 120 to the ink feeder 140 and the first buffer 352, meanwhile, the air is introduced into the housing 110 from the other end of the housing 110 in which the tip 160 is inserted, along the surfaces of the ribs 112a, 112b, 112c, 112d, 112e, 112f, 112g and 112h formed on the inner peripheral surface of the housing 110. Accordingly, the pressure in the space between the third buffer 356 and the other end of the housing 110 is maintained in a state of equilibrium to the atmosphere pressure.

The air introduced into the housing 110 moves to the reservoir 120 along the surfaces of the ribs 112a, 112b, 112c, 112d, 112e, 112f, 112g and 112h which come in contact with the outer peripheral surfaces of the first, second and third buffers 352, 354 and 356, while being absorbed in the buffers 353, 354 and 356.

The air absorbed in the buffers 352, 354 and 356 stays in a form of bubbles. When the ink is introduced from the reservoir 120 and the ink feeder 140 into the first and second buffers 352 and 354, the air moves to the reservoir 120 through the slit 134 formed in the head portion 132 of the ink supplying pipe 130. Accordingly, the air can compensate a drop of the pressure in the reservoir 120 which is caused as the ink moves from the reservoir 120 to the ink supplying pipe 130 and the first buffer 352.

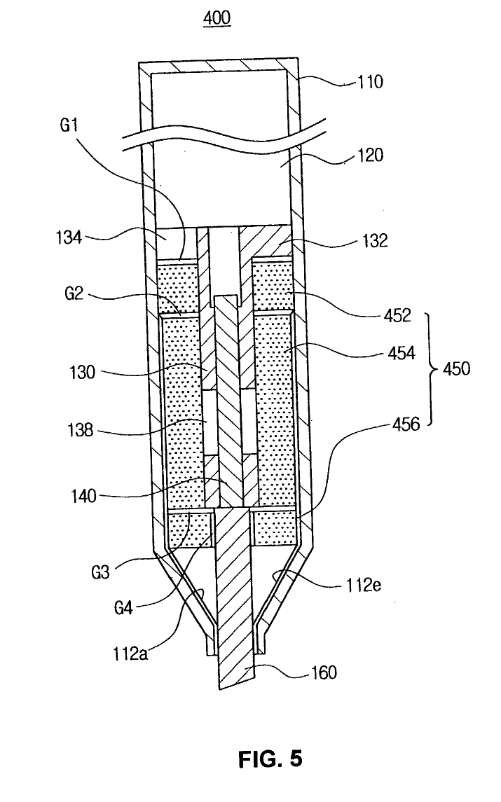

FIG. 5 is a longitudinally sectional view of a writing implement 400 according to the fourth embodiment of the present invention. As shown in FIG. 5, the writing implement 400 according to the fourth embodiment of the present invention has the same structure as that of the writing implement 300 according to the third embodiment of the present invention, except that a gap having a desired width is defined between a head portion of a ink supplying pipe and a first buffer while a gap having a predetermined width is defined between a third buffer and one end of the tip 160. Therefore, the like reference numeral indicates the like element.

A buffer 450 includes a first buffer 452, a second buffer 454 and a third buffer 456. The first buffer 452 and the second buffer 454 is disposed in the housing 110 to enclose the ink supplying pipe 130, while the third buffer 456 encloses the one end of the tip 160.

The first buffer 452 has a surface which is opposite to the head portion 132 of the ink supplying pipe 130 at a predetermined distance G1, and the other surface which faces to a surface of the second buffer 454 at a desired distance G2.

The other surface of the second buffer 454 of which one surface faces to the other surface of the first buffer, is opposite to a surface of the third buffer 456 at a desired distance G3. Further, the one surface of the third buffer 456 faces to a part of the ink supplying pipe 130.

The third buffer 456 has a larger diameter than that of the tip 160, of which an inner peripheral surface faces to the peripheral surface of the one end of the tip 160 at a desired distance G4.

Meanwhile, the ribs 112a, 112b, 112c, 112d, 112e, 112f, 112g and 112h formed on the inner peripheral surface of the housing 110 is placed in the gap G2 defined between the first buffer 452 and the second buffer 454. The air moves from the atmosphere into the housing 110 along the surfaces of the ribs 112a, 112b, 112c, 112d, 112e, 112f, 112g and 112h while being received in the gap G2 between the first buffer 452 and the second buffer 454.

A part of the air received in the gap G2 is introduced through the first buffer 452 into the gap G1 defined between the first buffer 452 and the head portion 132 of the ink supplying pipe 130, while the remainder of the air stays in the gap G2. The air introduced in the gap G1 moves to the reservoir 120 through the slit 134 formed in the head portion 132 of the ink supplying pipe 130 to compensate a drop of the pressure in the reservoir 120 when the ink moves from the reservoir 120 to the ink supplying pipe 130 and the first buffer 452.

In the writing implement 400 according to the fourth embodiment of the present invention which is constructed as described above, the ink is stored in the reservoir 120 of the housing 110. When a user uses the writing implement 400 or when the ink expands in response to the changes in temperature and pressure in the reservoir 120, the ink moves to the ink feeder 140 and the first buffer 452 through the ink supplying pipe 130, the slit 134 formed in the head portion 132 of the ink supplying pipe 130, and the gap G1.

Most of the ink is introduced into the ink supplying pipe 130, which is stored in the ink feeder 140. The remainder of the ink is introduced through the slit 134 and the gap G1 into the first buffer 452. The gap G2 defined between the first buffer 452 and the second buffer 454 restrains the ink introduced into the first buffer 452 from moving to the second buffer 454. The ink stored in the ink feeder 140 moves to the tip 160 by means of gravity and the capillarity of the ink feeder 140. The ink moving to the tip 160 in the ink feeder 140 is introduced into the second buffer 454 through the slot 138 of the ink supplying pipe until the pressure in the housing 110 makes a state of equilibrium to the atmosphere.

The ink introduced into the second buffer 454 is temporarily stored in the second buffer 454. The ink in second buffer 454 moves to the ink feeder 140 as the ink in the tip 160 is spent.

When the excessive ink is introduced from the ink feeder 140 into the tip 160, a part of the ink in the tip 160 moves to the third buffer 456 by the capillarity of the third buffer 456 to be stored in the third buffer 456. When the ink in the tip 160 is spent, then, the ink is introduced from the third buffer 456 and the ink feeder 140 to the tip 160.

While the ink moves from the reservoir 120 to the ink feeder 140 and the first buffer 452, meanwhile, the air is introduced into the housing 110 from the other end of the housing 110 in which the tip 160 is inserted, along the surfaces of the ribs 112a, 112b, 112c, 112d, 112e, 112f, 12g and 112h formed on the inner peripheral surface of the housing 110. Accordingly, the pressure in the space between the third buffer 456 and the other end of the housing 110 is maintained in a state of equilibrium to the atmosphere pressure.

The air introduced into the housing 110 moves to the reservoir 120 along the surfaces of the ribs 112a, 112b, 112c, 112d, 112e, 112f, 112g and 112h which come in contact with the outer peripheral surfaces of the first, second and third buffers 452, 454 and 456, while being absorbed in the buffers 453, 454 and 456.

The air absorbed in the buffers 452, 454 and 456 stays in a form of bubbles. When the ink is introduced from the reservoir 120 and the ink feeder 140 into the first and second buffers 452 and 454, the air moves to the reservoir 120 through the slit 134 formed in the head portion 132 of the ink supplying pipe 130. Accordingly, the air can compensate a drop of the pressure in the reservoir 120 which is caused as the ink moves from the reservoir 120 to the ink supplying pipe 130 and the first buffer 452.

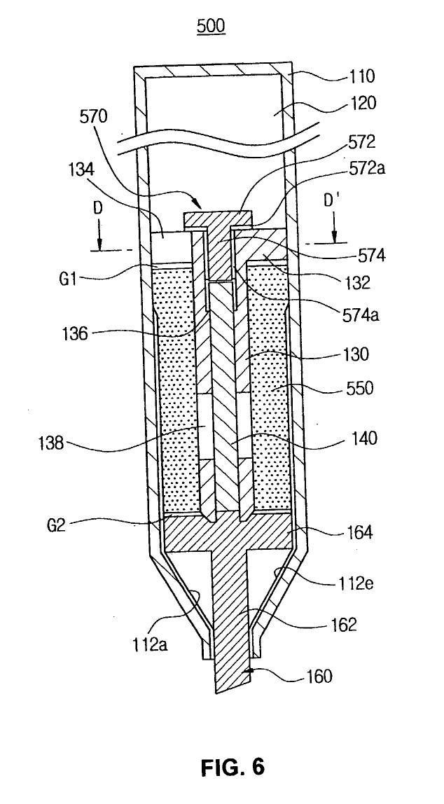

FIG. 6 is a longitudinally sectional view of a writing implement 500 according to the fifth embodiment of the present invention. As shown in FIG. 6, the writing implement 500 according to the fifth embodiment of the present invention includes a housing 110, a reservoir 120 for storing ink in the housing 10, an ink supplying pipe 130 which is communicated with the reservoir 120, for guiding flow of the ink, an ink feeder 140 which is disposed in the ink supplying pipe 130, for absorbing and storing the ink moving through the ink supplying pipe 130 from the reservoir 120 to control current rate of the ink, a tip 160 which is disposed in the housing 110, of which one end comes in contact with one ends of the ink supplying pipe 130 and the ink feeder 140 and of which the other end extends out of the housing 110, for conveying the ink from the ink feeder 140 to a substrate (not shown), a buffer 550 for temporarily storing the ink during a period of decreasing pressure differential between the reservoir 120 and the atmosphere, one end surface of the ink feeder 140 being in contact with a head portion 132 of the ink supplying pipe 130 at a desired distance G1, and the other end surface of the ink feeder 140 being contact with a disc portion 164 of the tip 160, and a decompression member which is partially inserted in the ink supplying pipe 130, for controlling the flow rate of the ink moving from the reservoir 120 to the ink supplying pipe 130.

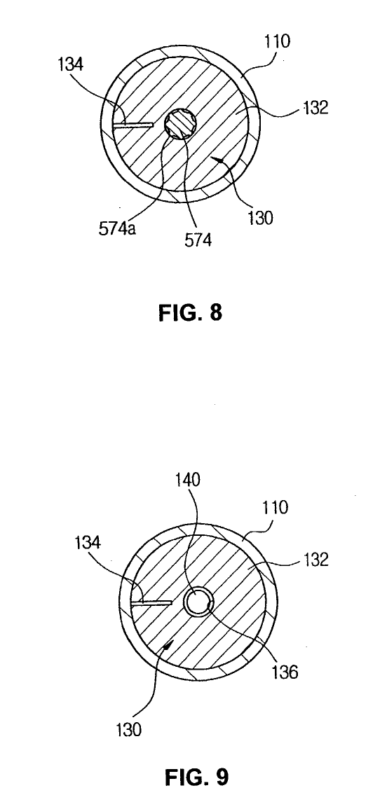

As shown in FIGS. 6 and 8, the ink supplying pipe 130 includes the head portion 132 which has a diameter corresponding to that of the housing 110 and in which a slit 134 is radially and outwardly formed at a position distanced from a center portion thereof. An outer peripheral surface of the head portion 132 comes in close contact with an inner peripheral surface of the housing 110. Meanwhile, an outer peripheral surface of one end of the ink supplying pipe 130 is cut off to be inclined at a desired angle. The one end of the ink supplying pipe 130 receives the one end of the tip 160 while pushing a surface of the disc portion 164 of the tip 160.

A step portion 136 is formed at a desired position on an inner peripheral surface of the ink supplying pipe 130. A thru-hole extending from the step portion 136 to the one end of the ink supplying pipe 130 has a smaller diameter than that of a thru-hole extending from the head portion 132 to the step portion 136.

As shown in FIG. 13, furthermore, a plurality of slots 138 are formed at a desired distance from one another along the outer peripheral surface of the ink supplying pipe 130 at a portion adjacent to the one end of the ink supplying pipe 130, through which the ink supplied to the ink feeder 140 moves to the buffer 550.

The area of the ink supplying pipe 130 in which the slots 138 are formed has a thickness of about 0.1 mm to 0.5 mm according to the properties of the ink, for examples surface tension, viscosity, specific gravity, and the like. When the ink supplying pipe 130 has the thickness less than 0.1 mm, the ink feeder 140 is placed adjacent to the buffer 550 in the presence of the slots 138 between the ink feeder 140 and the buffer 550, so that the ink excessively moves by the capillarity of the buffer 550 from the ink feeder 140 to the buffer 550. When the ink supplying pipe 130 has the thickness more than 0.5 mm, on the other hand, the ink feeder 140 is spaced apart from the buffer 550 in the presence of the slots 138 between the ink feeder 140 and the buffer 550, so that the capillarity of the buffer 550 cannot make an effect on the ink feeder 140 even if the excessive ink is supplied to the ink feeder 140. Thus, the excessive ink supplied to the ink feeder 140 does move not to the buffer 550 but to the tip 160.

The ink feeder 140 is inserted in the ink supplying pipe 130, of which one end extends through the step portion 136 of the ink supplying pipe 130 while coming in contact with the one end of the tip 160. The ink feeder 140 temporarily stores the ink introduced from the reservoir 120 into the ink supplying pipe 130, which regularly supplies the stored ink to the tip 160.

When the increase of the temperature and the pressure in the reservoir causes the excessive ink to move to the ink feeder 140, meanwhile, the ink leaks and moves through the slots 138 formed in the ink supplying pipe 130 from the ink feeder 140 to the buffer 550. The ink moving to the buffer 550 is absorbed by the capillarity of the buffer 550 to be temporarily stored in the buffer 550.

The buffer 550 is a porous and cylindrical tube made of synthetic material. The buffer 550 has one end which faces to the head portion 132 of the ink supplying pipe 130 at a desired distance G1 from the head portion 132, and the other end which is opposite to the disc portion 164 of the tip 160 at a predetermined distance G2 from the disc portion 164. The outer peripheral surface of the buffer 550 comes in close contact with the inner peripheral surface of the housing 110. Meanwhile, the certain portions of the outer peripheral surface of the buffer 150 contacting with the ribs 112a, 112b, 112c, 112d, 112e, 112f, 112g and 112h are inwardly pushed by means of the ribs 112a, 112b, 112c, 112d, 112e, 112f, 112g and 112h, as shown in FIGS. 11 and 12. Furthermore, the inner peripheral surface of the buffer 550 comes in tight contact with the outer peripheral surface of the ink supplying pipe 130.

The buffer 550 contains the air which is introduced into the housing 110 along the ribs 112a, 112b, 112c, 112d, 112e, 112f, 112g and 112h while the ink moves through the tip 160 to the substrate. In addition, the buffer 550 stores the ink which is introduced through the slit 134 which is formed in the head portion 132 of the ink supplying pipe 130, from the reservoir 120 into the buffer 550. The air stored in the buffer 550 partially moves to the reservoir 120 through the head portion 132 of the ink supplying pipe 130 until the pressure in the housing 110 makes in a state of equilibrium to the atmosphere pressure.

Further, the buffer 550 absorbs and temporarily stores the ink stored in the ink feeder 140 and the tip 160 by the capillarity thereof when the excessive ink is supplied to the ink feeder 140 and the tip 160.

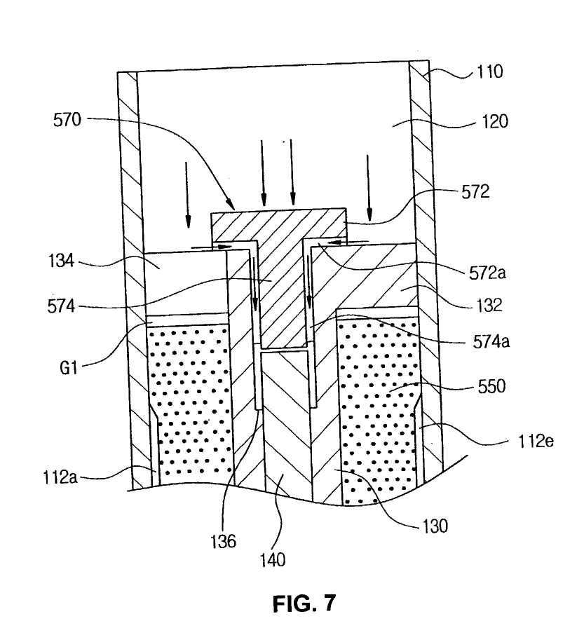

FIG. 7 is a partially enlarged sectional view of the writing implement 500 according to the fifth embodiment of the present invention, and FIG. 8 is a cross-sectional view of the writing implement 500 according to the fifth embodiment of the present invention, taken along a line D-D′ in FIG. 6.

As shown in FIGS. 7 and 8, the decompression member 570 has a head portion 572, a rod portion 574 which is integrally formed with the head portion 572 to extend into the ink supplying pipe 130, a first protrusion 572a which is radially formed at a desired distance from one another on a surface of the head portion 572, and a second protrusion 574a which is formed at a desired distance from one another in an axial direction on an outer peripheral surface of the rod portion 574 so as to be connected with the first protrusion 572a.

The first protrusion 572 of the decompression 570 comes in contact with an upper surface of the head portion 132, and the second protrusion 574 comes in contact with the inner peripheral surface of the ink supplying pipe 130. A plurality of grooves is defined between the first protrusions 572a and the second protrusions 574a of the decompression member 572, in which the ink flows.

The decompression member 572 guides the ink to flow along the grooves between the first protrusions 572a and the grooves between the second protrusions 574a when the ink moves into the ink supplying pipe 130, thereby controlling an amount of the ink introduced into the ink supplying pipe 130. Furthermore, the decompression member 570 restricts the flow of the ink in a direction indicated by arrows to control the current rate of the ink which is introduced into the ink supplying pipe 130.

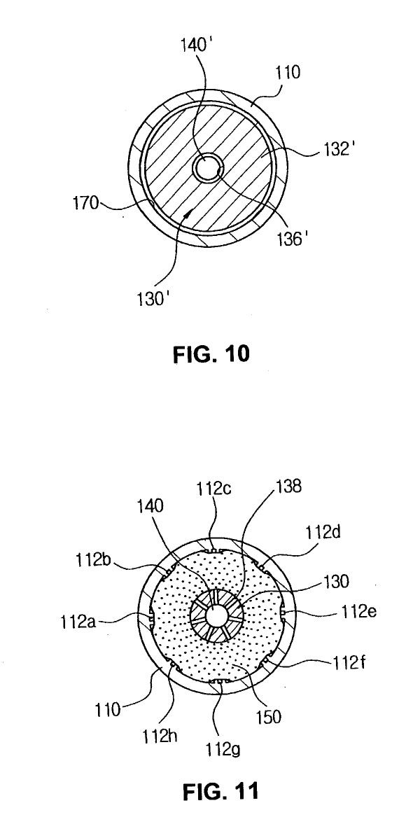

FIG. 10 is a cross-sectional view of the writing implement 100 according to the first embodiment of the present invention, taken along the line A-A′ in FIG. 2 in which a modification of the ink supplying pipe 130 is applied to the writing implement. As shown in FIG. 10, the ink supplying pipe 130′ applied to the first embodiment of the present invention includes a head portion 132′ having a smaller diameter than the inner diameter of the housing 110. When the ink supplying pipe 130′ is disposed in the housing 110, a gap 170 having a desired width is defined between an outer peripheral surface of the head portion 132′ of the ink supplying pipe 130′ and the inner peripheral surface of the housing 110.

The reservoir 120 is communicated by the gap 170 with the buffer 150. The air which is introduced into the housing 110 to be stored in the buffer 150, moves through the gap 170 to the reservoir 120 to compensate the pressure differential between the reservoir 120 and the atmosphere.

It is understood by those skilled in the art that the ink supplying pipe 130′ shown in FIG. 10 can be applied to the first embodiment as well as the remaining embodiments of the present invention.

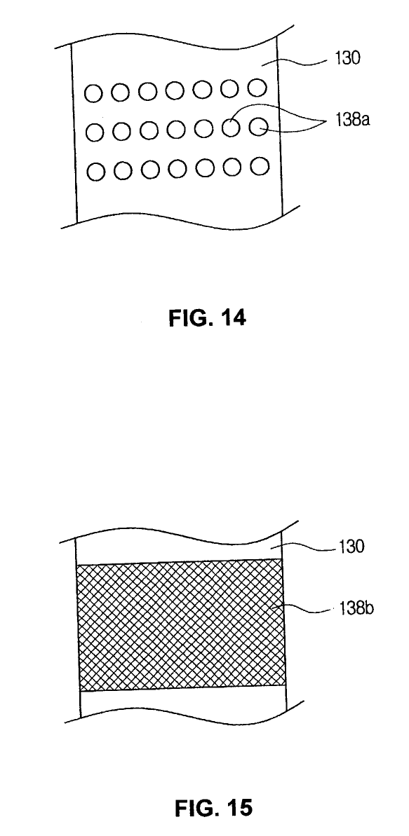

FIG. 14 is an exploded view of an example of the ink supplying pipe 138 applicable to the writing implement according to the first, second, third, fourth and fifth embodiments of the present invention, in which a plurality of through holes 183a is formed at a desired distance from one another along the outer peripheral surface of the ink supplying pipe 130.

FIG. 15 is an exploded view of the other example of the ink supplying pipe 138 applicable to the writing implement according to the first, second, third, fourth and fifth embodiments of the present invention, in which a mesh member 138b is installed in the ink supplying pipe 130.

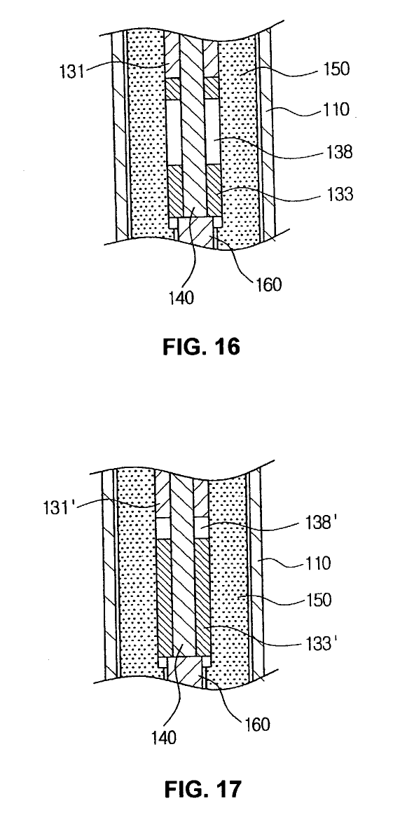

FIG. 16 is a partially sectional view of a first modification of the ink supplying pipe 130 applicable to the writing implement according to the first, second, third, fourth and fifth embodiments of the present invention. The ink supplying pipe includes a first ink supplying pipe 131 having the head portion as shown in FIG. 9 or 10 and a second ink supplying pipe 133 having the slot 138, the through holes 138a, or the mesh member 138b as shown in FIG. 13, 14, or 15. The second ink supplying pipe 133 is disposed between the first ink supplying pipe 131 and the tip 160. The ink feeder 140 is inserted in the first and second ink supplying pipes 131 and 133. Where the mesh member 138b is installed in the second ink supplying pipe 133, especially, the mesh member 138b is placed in a separate die in which the second ink supplying pipe is molded by injection molding of the synthetic resin.

FIG. 17 is a partially sectional view of a second modification of the ink supplying pipe applicable to the writing implement according to the first, second, third, fourth and fifth embodiments of the present invention. The ink supplying pipe includes a first ink supplying pipe 131′ having the head portion shown in FIG. 9 or 10 and a second cylindrical ink supplying pipe 133′ having a desired length. A sum of the length of the first ink supplying pipe 131′ and the length of the second ink supplying pipe 133′ is smaller than the length of the ink supplying pipe 130 shown in FIG. 1 or 16.

When the ink supplying pipe is disposed in the housing 110, the ink feeder 140 is inserted in the first and second ink supplying pipes 131′ and 133′ in the state of spacing at a desired distance between the first and second ink supplying pipes 131′ and 133′. At this time, the ink feeder 140 is inserted in order that the one end of the ink feeder 140 extends into the first ink supplying pipe 131′ and that the other end of the ink feeder 140 is placed on the same plane as the one end of the second ink supplying pipe 133′.

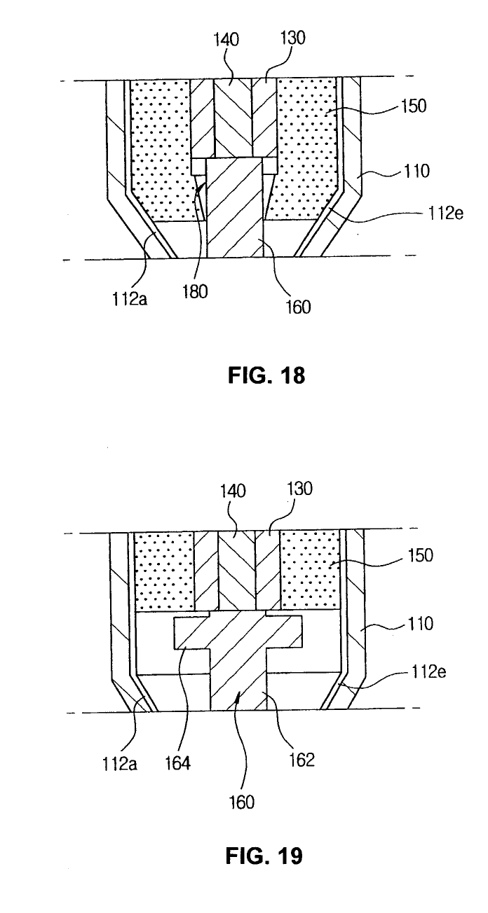

FIG. 18 is a sectional view of an intercepting member 180 applicable to the writing implement according to the first, second, third and fourth embodiments of the present invention. As shown in FIG. 18, the intercepting member 180 is disposed between the tip 160 and the one end of the buffer 150 enclosing the one end of the tip 160, in order to prevent the ink from flowing back from the tip 160 to the buffer 150. The intercepting member 180 is positioned for the tip 160 not to come in contact with the buffer 150.

The intercepting member 180 has a truncated conical shape, which has the same inner diameter as that of the tip 160 and the same outer diameter as that of the ink supplying pipe 130. The intercepting member 180 is disposed in the housing 110 so that a lower portion of the intercepting member 180 comes in contact with the one end of the ink supplying pipe 130 along with the one end of the tip 160.

FIG. 19 is a sectional view of a first modification of the tip 160 applicable to the writing implement according to the first, second, third, fourth and fifth embodiments of the present invention. As shown in FIG. 19, the tip 160 includes a rod portion 162 having desired length and diameter, and a disc portion 164 radially extending at a predetermined distance from a position adjacent to one end of the rod portion 162.

The disc portion 164 of the tip 160 has a smaller diameter than the inner diameter of the housing 110. The tip 160 is disposed in the housing 110 so that the one end of the rod portion 162 comes in contact with the ink supplying pipe 130 and the one end of the ink feeder 140. The peripheral surface of the disc portion 164 of the tip 160 faces at a desired distance to the inner peripheral surface of the housing 110.

The disc portion 164 of the tip 160 functions to temporarily receive the leaked ink when the ink is excessively stored in the buffer 550 and it causes the ink to leak from the buffer 550.

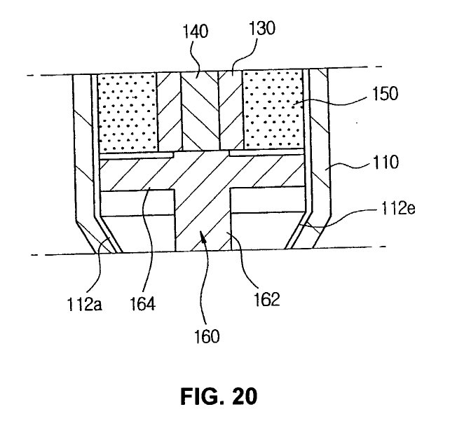

FIG. 20 is a sectional view of a second modification of the tip applicable to the writing implement according to the fifth embodiment of the present invention. As shown in FIG. 20, the tip 160 includes a rod portion 162 having desired length and diameter, and a disc portion 164 radially extending at a predetermined distance from a position adjacent to one end of the rod portion 162.

The disc portion 164 of the tip 160 has the same diameter as the inner diameter of the housing 110. The tip 160 is disposed in the housing 110 so that the one end of the rod portion 162 comes in contact with the ink supplying pipe 130 and the one end of the ink feeder 140. The peripheral surface of the disc portion 164 of the tip 160 comes in contact with the inner peripheral surface of the housing 110.

The disc portion 164 of the tip 160 functions to temporarily receive the leaked ink when the ink is excessively stored in the buffer 550 and it causes the ink to leak from the buffer 550.

In the writing implement according to the present invention which is constructed as described above, even though the ink excessively moves to the tip with expansion in response to change of temperature or pressure in the reservoir, the ink feeder and buffer temporarily stores a part of the ink, resulting in regularly supplying the ink to the tip.

While the present invention has been particularly shown and described with reference to a particular embodiment thereof, it will be understood by those skilled in the art that various changes in form and detail may be effected therein without departing from the spirit and scope of the invention as defined by the appended claims.

What is claimed is:

1. A writing implement comprising:
a housing;
a reservoir for storing ink within the housing;
an ink supplying pipe which is communicated with the reservoir, for guiding flow of the ink;
an ink feeder which is disposed in the ink supplying pipe, for absorbing and storing the ink which flows through the ink supplying pipe from the reservoir so as to control a current rate of the ink;
a buffer which is disposed in the housing with enclosing an outer peripheral surface of the ink supplying pipe, for temporally storing the ink during reducing pressure differential between the reservoir and atmosphere; and
a tip which is disposed in the housing, for conveying the ink from the ink feeder to a substrate, the tip having one end which comes in contact with one ends pf the ink supplying pipe and the ink feeder and the other end which extends out of the housing.

2. The writing implement as claimed in claim 1, wherein a plurality of ribs are formed at a distance from one another on an inner peripheral surface of the housing to extend at a predetermined length from an end of the housing, along which air moves into the housing when the ink is conveyed from the tip to the substrate.

3. The writing implement as claimed in claim 2, wherein the ink supplying pipe includes a head portion which has a diameter corresponding to an inner diameter of the housing and in which a slit is radially formed at an area spaced at a predetermined distance apart from a center thereof.

4. The writing implement as claimed in claim 2, wherein the ink supplying pipe includes a circular head portion which has a smaller diameter than an inner diameter of the housing.

5. The writing implement as claimed in claim 3, wherein a plurality of slots are formed at a predetermined distance from one another along the outer peripheral surface of the ink supplying pipe, through which excessive ink supplied to the ink feeder moves to the buffer.

6. The writing implement as claimed in claim 3, wherein a plurality of thru-holes are formed at a predetermined distance from one another along the outer peripheral surface of the ink supplying pipe, through which excessive ink supplied to the ink feeder moves to the buffer.

7. The writing implement as claimed in claim 2, wherein the ink supplying pipe includes a first ink supplying pipe having a head portion which has a diameter corresponding to an inner diameter of the housing and in which a slit is radially formed at an area spaced at a predetermined distance apart from a center of the head portion, and a second ink supplying pipe which is disposed between the first ink supplying pipe and the tip.

8. The writing implement as claimed in claim 2, wherein the ink supplying pipe includes a first ink supplying pipe having a circular head portion which has a smaller diameter than an inner diameter of the housing, and a second ink supplying pipe which is disposed between the first ink supplying pipe and the tip.

9. The writing implement as claimed in claim 7, wherein a plurality of slots are formed at a predetermined distance from one another along an outer peripheral surface of the second ink supplying pipe, through which excessive ink supplied to the ink feeder moves to the buffer.

10. The writing implement as claimed in claim 7, wherein a plurality of thru-holes are formed at a predetermined distance from one another along an outer peripheral surface of the second ink supplying pipe, through which excessive ink supplied to the ink feeder moves to the buffer.

11. The writing implement as claimed in claim 7, wherein a mesh member is installed at an intermediate portion in the second ink supplying pipe, through which excessive ink supplied to the ink feeder moves to the buffer.

12. The writing implement as claimed in claim 3, wherein the buffer has one end which comes in contact with the head portion of the ink supplying pipe and the other end which encloses one end of the tip, of which the outer peripheral surface comes in contact with the inner peripheral surface of the housing.

13. The writing implement as claimed in claim 3, wherein the buffer has one end which is spaced at a predetermined distance apart from the head portion of the ink supplying pipe and the other end which is spaced at a predetermined distance from a peripheral surface of the one end of the tip with enclosing, of which the outer peripheral surface comes in contact with the inner peripheral surface of the housing.

14. The writing implement as claimed in claim 3, wherein the buffer includes a first, second and third buffers which are arranged at a predetermined distance, the first and second buffers being disposed to enclose the ink supplying pipe, and the third buffer being disposed to enclose the one end of the tip.

15. The writing implement as claimed in claim 14, wherein the first buffer is spaced at a predetermined distance apart form the head portion of the ink supplying pipe, and the third buffer is spaced at a predetermined distance apart from the peripheral surface of the one end of the tip to enclose the tip.

16. The writing implement as claimed in claim 15, wherein one ends of the ribs are positioned in a gap between the first buffer and the second buffer.

17. The writing implement as claimed in claim 3, further comprising a pressure reducing member for reducing a current rate of the ink moving to the ink buffer, which includes a head portion, a rod portion integrally formed with the head portion to extend into the ink supplying pipe, a plurality of first protrusions which are radially formed at a predetermined distance from one anther on a lower surface of the head portion, and second protrusions which are formed at a predetermined distance from one another in an axial direction on an outer peripheral surface of the rod portion to respectively come in contact with the first protrusion of the head portion.

18. The writing implement as claimed in claim 2, wherein the tip includes a rod portion having a predetermined length and a disc portion extending radially at a predetermined length at a position adjacent to one end of the rod portion.

19. The writing implement as claimed in claim 18, wherein a gap is defined between the disc portion of the tip and the buffer.

20. The writing implement as claimed in claim 3, wherein an intercepting member is disposed between the tip and one end of the buffer enclosing the one end of the tip, in order to prevent the ink from flowing back from the tip to the buffer.
